(19) United States
(12) Patent Application Publication
(10) Pub. No.: US 2024/0140789 A1
(43) Pub. Date: May 2, 2024

(54) SYSTEM TO PRODUCE ULTRAPURE HYDROGEN FROM AMMONIA

(71) Applicant: TECHNISCHE UNIVERSITEIT EINDHOVEN, Eindhoven (NL)

(72) Inventors: Valentina CECHETTO, Eindhoven (NL); Luca DI FELICE, Eindhoven (NL); Fausto GALLUCCI, Eindhoven (NL)

(21) Appl. No.: 18/280,911

(22) PCT Filed: Mar. 9, 2022
(86) PCT No.: PCT/NL2022/050128

§ 371 Date: Sep. 7, 2023

(30) Foreign Application Priority Data
Mar. 9, 2021 (NL) 2027727

(51) Int. Cl. C01B 3/04; C01B 3/58

(52) U.S. Cl. CPC C01B 3/047; C01B 3/58; C01B 2203/1011

(57) ABSTRACT

The present invention relate to a system for producing hydrogen from ammonia, the system comprising: a membrane reactor comprising membranes for selectively permeating hydrogen; adsorption columns for adsorbing ammonia; and a heat integration system configured to: supply heat to the inlet of the membrane reactor, recover heat from the outlet of the membrane reactor, and regenerate the absorption columns via the recovered heat.

The present invention relates to a system for producing hydrogen from ammonia. In addition, the present invention also relates to the use of hydrogen thus produced.

Over the last decades, hydrogen (H₂) has gained considerable attention as an ideal and clean energy carrier. Its reaction with oxygen produces in fact only water as by-product and high efficiencies for energy conversion are achieved when hydrogen is employed as feedstock for power production in fuel cells (FCs). However, its low volumetric energy density and the difficulties associated with gas handling are the main drawbacks associated to hydrogen which have so far prevented H₂-based technologies to achieve popularity for commercial applications in the power production field.

A possible solution to overcome these drawbacks consists in storing hydrogen in the chemical bonds of hydrogen carrier compounds. Liquid fuels generated from hydrogen, such as methanol, ammonia and formic acid could in fact be easily transported over long distances, stored next to H₂ refueling stations for long time and H2 could be later recovered in-situ when required.

Among all the possible candidates, ammonia (NH₃) is a particularly promising hydrogen carrier due to its high volumetric energy density, relatively low cost and ease of liquefaction, storage and transportation compared to compressed hydrogen. Since it can be liquefied at higher temperature and lower pressure compared to hydrogen, ammonia liquefaction is in fact less energy intensive and, consequently, its storage and transportation can be carried out in smaller and lighter vessels compared to hydrogen. Moreover, the absence of carbon in its molecular structure makes ammonia an attracting and promising route for the production of H₂ to be used in proton exchange membrane fuel cells (PEMFCs) for power production. In fact, while H₂ traditionally produced from the reforming of fossil fuels in large scale plants inevitably contains COₓ which are responsible for the poisoning of the cell electrodes (even when COₓ concentrations are at ppms level) NH₃ is carbon-free.

However, in view of the possibility to use the NH₃-derived H2 for fuel cell applications or other applications where ultra-pure H₂ has to be used as feedstock, hydrogen with virtually no ammonia content is required.

CN108854928 relates to a method for preparing a double-effect dense ceramic membrane reactor for hydrogen production by ammonia decomposition reaction and separation, which realizes that the decomposition reaction of ammonia and the purification of hydrogen are carried out simultaneously in the same unit. Such method includes the following steps: preparation of tubular dense ceramic hydrogen permeable membrane, preparation of nickel catalyst with tubular dense ceramic hydrogen permeable membrane raw material as carrier, sleeve the quartz tube on the outside of permeable membrane, and the nickel catalyst is filled in the quartz tube and sealed with a sealing head to form a double-effect dense ceramic membrane reactor for ammonia decomposition hydrogen production reaction and separation.

An object of the present invention is to produce ultra-pure hydrogen that can be used to fuel cell applications or any other application which requires ultra-pure H₂ as a feedstock.

An object of the present invention is to produce ultra-pure hydrogen in an energy friendly way wherein the production of heat and the consumption of heat is internally connected, i.e. a heat integrated construction.

An object of the present invention is to produce hydrogen in a continuous mode wherein the hydrogen thus produced has been stripped of unwanted impurities.

The present invention relates to a system for producing hydrogen from ammonia, the system comprising: a membrane reactor comprising membranes for selectively permeating hydrogen; adsorption columns for adsorbing ammonia; and a heat integration system configured to:
supply heat to the inlet of the membrane reactor,
recover heat from the outlet of the membrane reactor, and
regenerate the absorption columns via the recovered heat.

The present inventors found that the hydrogen stored in its chemical bond has to be recovered through ammonia decomposition into H₂ and N₂. Subsequently, the H₂ produced has to be separated from N₂ and purified from possible traces of unconverted ammonia in order to meet the specifications required for a correct functioning of a specific application, such as a fuel cell.

The present inventors found that the membrane reactor is an apparatus for reducing the footprint of conventional systems for efficient H₂ recovery from NH₃. In the membrane reactor NH₃ decomposition into H₂ and N₂ and high-purity H2 separation are simultaneously performed. Moreover, since NH₃ decomposition is limited by the thermodynamic equilibrium, the selective H₂ separation performed by means of membranes shifts the thermodynamic equilibrium of reaction allowing the system to go beyond its thermodynamic constraint.

The use of a membrane reactor for ammonia decomposition shows several advantages over conventional systems for NH₃ conversion into pure H₂. Among them, the possibility to avoid the introduction in the system of any costly downstream separation unit for H₂ purification from N₂, the consequent break down of the capital cost of the system and the possibility to achieve high H₂ separation efficiency at lower operating temperature compared to other technologies, leading to energetic and economic benefits.

However, in view of the possibility to use the NH₃-derived H₂ for FC (Fuel Cell) applications, the purity achieved with this technology is not sufficiently high to directly feed H₂ to the FC. Any residual NH₃ concentration above 0.1 ppm in the permeate would in fact prevent H₂ from being used directly as fuel for PEM FCs. As it has been experimentally demonstrated that even equipping the reactor with membranes with very high selectivity towards H₂ it is not possible to meet the specifications regarding the FC limit on the residual NH₃ concentration, a H₂ purification stage downstream the membrane reactor is hence needed.

Yet, the introduction of a purification stage for residual NH₃ removal from H₂ produced makes the system more complex, but makes ammonia a hydrogen carrier which can be in-situ exploited for power production when needed.

In an example of the present system the membrane reactor comprises hydrogen selective membranes immersed in a catalyst bed.

In an example of the present system the catalyst bed is a packed bed of particles or structured catalyst, especially a high thermal conductive structured or 3D structure including a metal having catalytic activity for ammonia decomposition.

In an example of the present system the hydrogen selective membranes are positioned above the bottom of the catalyst bed located within the membrane reactor.

In an example of the present system the hydrogen selective membranes are closed at its bottom side and open at its top side.

In an example of the present system multiple adsorption columns are arranged for adsorption and regeneration functions.

In an example of the present system the hydrogen selective membranes have a perm-selectivity H₂/N₂ of at least 5000, preferably >10.000.

In an example of the present system the system further comprises a burner for supplying the energy required for the decomposition of ammonia in hydrogen and nitrogen to the membrane reactor.

In an example of the present system the residual heat of exhaust gases leaving the burner is used for heating up the ammonia feed to the membrane reactor.

In an example of the present system the retentate from the membrane reactor is combusted in the burner.

In an example of the present system the heat of the hydrogen permeated through the membranes is recovered and supplied to adsorption columns for regeneration thereof.

In an example of the present system the output or effluent of adsorption columns in regeneration mode is combusted in the burner.

In an example of the present system the hydrogen permeated through the membranes is supplied to adsorption columns for adsorbing impurities, such as unconverted ammonia.

The present invention also relates to hydrogen having a purity of at least 99.98 mol. % and an ammonia concentration of <0.01 ppm as produced in a system as discussed above.

An example of the application of the ultra-pure hydrogen produced in a system as discussed above is a fuel cell. The term ultra-pure hydrogen refers to Ultrapure hydrogen according to ISO 14687:2019 and more specifically according to ISO 14687-2 and category 3 of ISO 14687-3.

The present invention also relates to a method for producing hydrogen from ammonia, comprising the following steps:
supplying ammonia to a membrane reactor comprising membranes for selectively permeating hydrogen;
decomposing ammonia in the membrane reactor into hydrogen and nitrogen;
supplying hydrogen from the membrane reactor to adsorption columns for removing impurities from the hydrogen;
wherein heat is supplied to the inlet of the membrane reactor and heat is recovered from the outlet of the membrane reactor, and
regenerating the absorption columns via the recovered heat.

In an example ammonia decomposition has been performed over a conventional Ru-based catalyst, while double-skin Pd-based membranes and zeolite 13X were used for hydrogen separation and hydrogen purification from residual NH₃, respectively.

The preparation of the Pd—Ag membranes is carried out into two steps, wherein the first step consists in the coating of the porous supports and, specifically, it is carried out by co-depositing a Pd—Ag layer onto porous tubular alumina (α-Al₂O₃) asymmetric supports (14/7 mm OD/ID) with a top layer pore size of 100 nm from Rauschert Kloster Veilsdor. The co-deposition has been performed via electroless plating, a technique which consists of a first activation of the support with Pd seeds and a subsequent immersion of the support in a bath containing a Pd—Ag solution to produce the selective layer. The thickness of this layer proportionally increases with the plating time, therefore different plating times are set in order to obtain membranes with different permeation properties. Two membranes have been used, one with selective layer of ˜1 μm and one with selective layer of ˜6-8 μm. The second step of the membrane preparation consists in the deposition of a porous protective layer by dip-coating over the selective layer. This protective layer, which is a porous Al₂O₃-YSZ (yttria-stabilized zirconia) layer of 50 wt. % of YSZ with thickness of ˜1 μm, aims at improving the membrane stability as it avoids any possible interaction between the selective layer and the catalyst in which the membrane will be immersed during application.

The present inventors found that increasing the membrane thickness from ˜1 μm to ˜6-8 μm during ammonia decomposition at 500° C. and 4 bar, hydrogen recovery decreases from 93.2% to 84.8%, while ammonia concentration in the permeate significantly decreases from 47 ppm to a value which is below the detection limit of the FTIR that was used to measure the NH₃ content of the hydrogen stream. Thus by adequately increasing the thickness of the membrane selective layer it is possible to achieve hydrogen purities compatible with the specifications imposed by fuel cells. Thus by increasing the membrane thickness above 6 μm fuel cell grade hydrogen can be obtained at reactor pressures below 5 bar.

The invention is explained in more detail below using embodiment examples, for which:

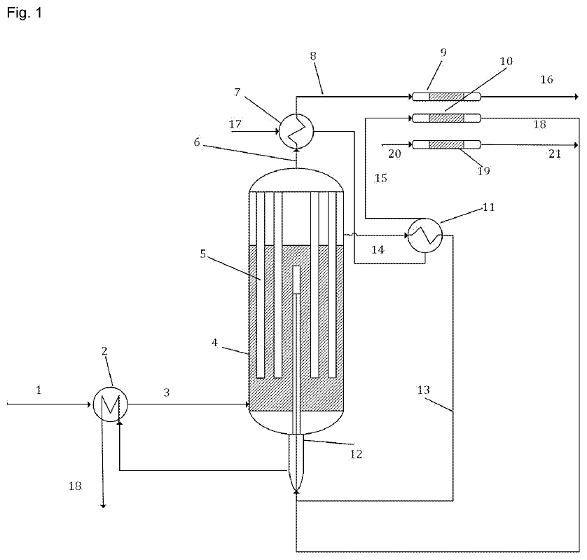

FIG. 1 shows a process scheme of an embodiment of the system for producing hydrogen from ammonia according to the invention. In the figure, the same designations refer to equivalent parts;

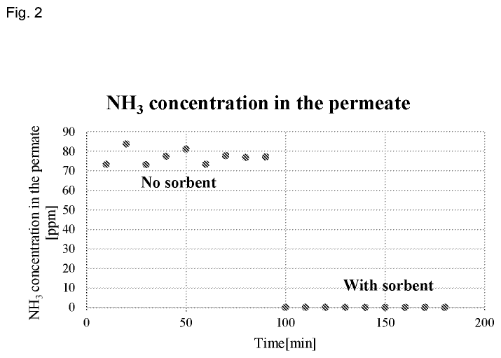

FIG. 2 shows the influence of the introduction of a hydrogen cleaning unit on the purity of hydrogen produced from ammonia decomposition.

According to FIG. 1 the ammonia feed (1) is heated up to the reaction temperature in a heat exchanger (2) where the residual heat of the exhaust gases leaving the burner (12) is exploited. The cooled flue gases (18) leave then the system at temperature lower than 150° C., whereas the heated feed (3) enters the membrane reactor (4) where hydrogen selective membranes (5) are immersed in a catalyst bed available in the form of small particles or 3D printed structures. The membranes should preferably stay at least 10 cm above the bottom of the catalyst bed and are preferentially with a finger-like configuration (thus closed at the bottom). The use of this type of supports, in fact, usually results in more selective membranes compared to membranes requiring the sealing at both ends, as in the dead-end configuration the number of sealing points is lower compared to the membranes requiring the sealing at both ends. On the catalyst bed ammonia decomposes into hydrogen and nitrogen and hydrogen selectively permeates thorough the membranes together with small amounts of ammonia (ppm levels). In this system the ammonia feed is pre-heated up to the reactor operating temperature and then enters the reaction unit in which ammonia decomposes into hydrogen and nitrogen after contacting a suitable catalyst for ammonia decomposition. As the membranes are immersed in the catalyst bed, hydrogen containing traces of unconverted ammonia permeates through the membranes and leaves the reactor at high temperature. Nitrogen resulting from ammonia decomposition, unrecovered hydrogen and unconverted ammonia leave the reactor at the retentate side at the reactor operating pressure and temperature.

As ammonia decomposition is a mildly endothermic reaction, heat must be supplied in order to keep the reactor temperature at the desired level. Since this technology has no carbon footprint, the retentate of the reactor (14) which contains unrecovered H₂ and unconverted ammonia is combusted in presence of air in a burner (12) and the heat generated from this combustion is used to supply the energy required for the process. As the reactor retentate leaves the membrane reactor at the reaction temperature (400-450° C.), before its combustion the heat available in this stream is exploited in a heat exchanger (11) where the comburent air stream is pre-heated. The hydrogen permeated through the membranes (6) is first cooled down in a heat exchanger (7) and then (8) fed to an adsorption column (9) where ammonia is captured (adsorbed) and the ultra-pure hydrogen is produced (16). The heat recovered from H2 cooling (15) is used to regenerate the sorbent in the column (10). The comburent air is also used for the heat management of the system. Prior combustion, in fact, the pre-heated air stream (15) is also used to regenerate the adsorption column (10) and the gas leaving column 10 (stream 18) is sent to the burner. In order to optimize the regeneration, the cleaning system preferably consists of three columns. Column 9 is at low temperature and used to adsorb the traces of ammonia (and possibly other contaminants). The outlet of this column is therefore pure hydrogen. While column 9 is used for H₂ purification and therefore is in “adsorption mode”, column 10 and column 19 are operated in the “regeneration mode”. A stream of hot air (15) is sent to column 10, in which thanks to the heat released by the air stream the previously adsorbed ammonia when the columns was used in H₂ purification mode is desorbed. The outlet (18) warm air containing traces of ammonia is then used as comburent in the burner. Column (19) is cooled with cold air (20) and the warm air available at its outlet is also sent to the burner. Preferably, the ratio between air stream 17 and air stream 20 is done such that each step of the three columns has the same time. In this way, it is therefore possible to switch the three columns between each other for continuous production of ultrapure hydrogen.

In an example the hydrogen production unit includes two columns, which are simultaneously working, but into two different modes. While one column works for the removal of ammonia from the hydrogen stream, the other one works in regeneration mode. The heat recovered from the cooling of both the permeate and retentate stream is exploited for the saturated sorbent regeneration, as high temperature favors ammonia desorption from the adsorbent material. The off-gas leaving the regeneration column is sent to the burner to be combusted together with the retentate stream. When working in regeneration mode, a column may also be fed with inert gas (nitrogen for instance) which could serve as a purge for ammonia that desorbs from the adsorbent material. Once the column working in adsorption mode is saturated with ammonia, its functioning is switched to regeneration mode, and at the same time the column working in regeneration mode is switched to adsorption mode. The continuous switching of the columns from adsorption to regeneration mode ensures a continuous pure hydrogen purification process.

In view of the possibility to use NH₃-derived H₂ as fuel for systems requiring ultra-pure hydrogen, such as fuel cells, the hydrogen produced from ammonia in a catalytic membrane reactor needs to be cleaned to remove the unconverted residual ammonia.

Permeation tests for H₂/NH₃ mixtures have been carried out at lab scale in a membrane reactor where a Pd-based membrane with dead-end configuration was used for selective H₂ separation. Goal of these experiment was to demonstrate that by forcing the produced H₂ with traces of ammonia to pass through a column filled with adsorbent material it is possible to reduce the ammonia content of the stream and therefore produce ultra-pure H₂ which can then be used as suitable fuel for systems requiring ultra-pure hydrogen. Different mixture compositions and permeation temperatures were selected. Specifically, H₂ separation has been performed at 400° C., 425° C. and 450° C. for H2/NH3 mixtures containing 5%, 10% and 15% of NH₃. The reactor was operated at 3 bar under a feed flow rate of 2 LN/min and the permeate side of the membrane was kept at atmospheric pressure. The ammonia concentration at the permeate side of the membrane was connected to a purification stage, in which a bed of zeolite 13X was used as sorbent material for ammonia. The ammonia concentration (ppm level) was measured upstream and downstream the hydrogen purification unit. The results of these tests show that by using a sorbent such as zeolite 13X for the removal of residual ammonia it is possible to reduce the NH₃ concentration of the produced H₂ stream to 0 ppm and consequently achieve the desired hydrogen purity. The same result could also be obtained with any other adsorbent capable of adsorbing ammonia.

Table 1 NH₃ content and purity of hydrogen produced before and after residual ammonia removal at 400° C., 425° C. and 450° C. and for different membrane feed compositions.

| | NH₃ concentration in the permeate | | | | | |
|---|---|---|---|---|---|---|
| NH₃ | 400° C. | | 425° C. | | 450° C. | |
| concentration | | Zeolite | | Zeolite | | Zeolite |
| in the feed | — | 13X | — | 13X | — | 13X |
| 5% | 223.10 | 0.00 | 85.98 | 0.00 | 89.92 | 0.00 |
| 10% | 149.49 | 0.00 | 125.13 | 0.00 | 125.13 | 0.00 |
| 15% | 218.46 | 0.00 | 64.39 | 0.00 | 88.91 | 0.00 |

In order to prove the stability of the process, the influence of the presence of a hydrogen cleaning unit downstream the membrane reactor was investigated in a 3 h experiment where after 90 minutes of operation the hydrogen permeate stream leaving the reactor was connected to the hydrogen cleaning unit. The results of this experiment, which are presented in FIG. 2, show that a clear transition is visible between the two conditions investigated. When the permeated hydrogen is forced to pass through the ammonia removal unit, a sharp decrease in the NH₃ concentration is in fact detected. Overall, the process has shown very good stability.

FIG. 2: Influence of the introduction of a hydrogen cleaning unit on the purity of hydrogen produced from ammonia decomposition. The experiment was carried out at 400° C., 3 bar(a) and a feed flow rate of 2 LN/min of a H₂/NH₃ mixture containing 95% (mol.) of hydrogen

The present invention thus relates to a system comprising a Pd based membrane reactor where the ammonia decomposition takes place and hydrogen (with low ppm of ammonia) is separated through the membrane. The permeate side is treated in a Temperature Switch Adsorption (TSA) system comprising an adsorbent for the adsorption of the ammonia. The heat in the permeate hydrogen and retentate is used to regenerate the ammonia sorbent by increasing the temperature. The hydrogen exiting the system is ultrapure with (virtually) zero content in ammonia.

1. A system for producing hydrogen from ammonia, the system comprising:
a membrane reactor comprising membranes for selectively permeating hydrogen;
adsorption columns for adsorbing ammonia; and a heat integration system configured to:
supply heat to the inlet of the membrane reactor,
recover heat from the outlet of the membrane reactor, and
regenerate the absorption columns via the recovered heat.

2. A system according to claim 1, wherein the membrane reactor comprises hydrogen selective membranes immersed in a catalyst bed.

3. A system according to claim 2, wherein the catalyst bed is a packed bed of particles or structured catalyst, especially a high thermal conductive structured or 3D structure including a metal having catalytic activity for ammonia decomposition.

4. A system according to any one or more of claims 2-3, wherein the hydrogen selective membranes are positioned above the bottom of the catalyst bed located within the membrane reactor.

5. A system according to any one or more of claims 2-4, wherein the hydrogen selective membranes are closed at its bottom side and open at its top side.

6. A system according to any one or more of the preceding claims, wherein multiple adsorption columns are arranged for adsorption and regeneration functions.

7. A system according to any one or more of the preceding claims, wherein the sorbent in the adsorption columns has a sorption capacity for ammonia of at least 0.01 mmol/g at a concentration of <150 ppm in hydrogen.

8. A system according to any one or more of the preceding claims, wherein the hydrogen selective membranes have a perm-selectivity H₂/N₂ of at least 5000, preferably >10.000.

9. A system according to any one or more of the preceding claims, wherein the system further comprises a burner for supplying the energy required for the decomposition of ammonia in hydrogen and nitrogen to the membrane reactor.

10. A system according to claim 9, wherein the residual heat of exhaust gases leaving the burner is used for heating up the ammonia feed to the membrane reactor.

11. A system according to any one or more of claims 9-10, wherein the retentate from the membrane reactor is combusted in the burner.

12. A system according to any one or more of the preceding claims, wherein the heat of the hydrogen permeated through the membranes is recovered and supplied to adsorption columns for regeneration thereof.

13. A system according to any one or more of the preceding claims, wherein the output of adsorption columns in regeneration mode is combusted in the burner.

14. A system according to any one or more of the preceding claims, wherein the hydrogen permeated through the membranes is supplied to adsorption columns for adsorbing impurities, such as unconverted ammonia.

15. A method for producing hydrogen from ammonia, comprising the following steps:
supplying ammonia to a membrane reactor comprising membranes for selectively permeating hydrogen;
decomposing ammonia in the membrane reactor into hydrogen and nitrogen;
supplying hydrogen from the membrane reactor to adsorption columns for removing impurities from the hydrogen;
wherein heat is supplied to the inlet of the membrane reactor and heat is recovered from the outlet of the membrane reactor, and
regenerating the absorption columns via the recovered heat.

16. Hydrogen having a purity of at least 99.98 mol. % and an ammonia concentration of <0.01 ppm produced in a system according to any one or more of the preceding claims.

17. The use of hydrogen according to claim 16 in a fuel cell.
